(19) United States
(12) Patent Application Publication
(10) Pub. No.: US 2016/0222859 A1
(43) Pub. Date: Aug. 4, 2016

(54) METHOD AND SYSTEM FOR DETECTING MALFUNCTIONING OF FLUID TANK OF MACHINE

(71) Applicant: Caterpillar Inc., Peoria, IL (US)

(72) Inventor: Keith D. Hogan, Peoria Heights, IL (US)

(73) Assignee: Caterpillar Inc., Peoria, IL (US)

(21) Appl. No.: 15/095,099

(22) Filed: Apr. 10, 2016

(51) Int. Cl. F01N 11/00; G01F 23/00; F16K 37/00

(52) U.S. Cl. CPC F01N 11/00; F16K 37/00; G01F 23/00; F01N 2550/05

(57) ABSTRACT

A method is disclosed for detecting a malfunctioning of a tank containing fluid, using a processor and a level sensor. The processor calculates a rate of consumption of the fluid in the tank. The processor further calculates an estimated change in level of the fluid in the tank based on the rate of consumption of the fluid. The level sensor determines a measured change in level of the fluid in the tank. The processor compares the estimated change in level of the fluid with the measured change in level of the fluid. The processor further determines the malfunctioning of the tank if a difference between the estimated change in level of the fluid and the measured change in level of the fluid exceeds a predetermined value. The fluid contained in the tank is a diesel exhaust fluid.

### TECHNICAL FIELD

The present disclosure relates to a fluid tank of a machine, and more specifically, to a method for detecting a malfunctioning of the tank containing the fluid.

### BACKGROUND

Machines employing diesel engines generally use an after-treatment system. The after-treatment system utilizes a selective catalytic reduction (SCR) process for treating exhaust emissions. The SCR process includes reducing nitrogen oxide (NOₓ) emissions to nitrogen (N₂), water (H₂O), and carbon dioxide (CO₂), by using a reducing agent, known as diesel exhaust fluid (DEF). The diesel exhaust fluid (DEF) is a clear non-hazardous liquid made up of a solution of about 32.5% high-purity urea in de-mineralized water. A small quantity of the DEF is injected into high temperature exhaust stream upstream of a SCR catalyst, where the DEF vaporizes and decomposes to form ammonia (NH₃) and carbon dioxide (CO₂). Further, the ammonia in conjunction with the SCR catalyst converts the (NOₓ) to harmless nitrogen (N₂) and water (H₂O).

Typically, the DEF is stored in tanks for dispensing at a customer's site where the DEF is replenished in a machine. The tank includes a cap with air passages in it or the tank is coupled to a breather system which is adapted to facilitate exchange of air between the tank and atmosphere. The exchange of air between the tank and the atmosphere helps in maintaining atmospheric pressure inside the tank. The tank is further coupled to a pump and a dispensing system for drawing the DEF out of the tank. The air passages in the cap of the tank or the breather system can get blocked with debris in the surrounding environment or with crystallized urea, left after vaporization of water from the DEF. The blockage of the cap or the breather system creates a vacuum inside the tank leading to shrinkage of the tank. Further, the ability of the pump to draw the DEF out of the tank reduces drastically due to creation of vacuum inside the tank. The blockage of the cap or the breather system, if left unnoticed, leads to degradation in performance of the after-treatment system. Therefore, there is a need for a method that can detect the blocked cap of the tank storing the DEF or the blocked breather system coupled to the tank storing the DEF immediately so that they can be replaced without affecting the performance of the after-treatment system.

U.S. Pat. No. 5,339,788 discloses an arrangement for conducting a tank-venting diagnosis for a motor vehicle equipped with a tank-venting apparatus. The tank-venting apparatus includes a tank-venting valve actuated by an actuator between an open position and a closed position. The arrangement includes a pressure-difference sensor means for measuring the underpressure, and a control means having a sequence control/diagnosis unit connected to the pressure-difference sensor for receiving a signal indicative of the measured underpressure. The sequence control/diagnosis unit is adapted to determine when the measured underpressure exceeds a threshold underpressure and to emit a signal to the actuator for closing said tank-venting valve. However, such an arrangement is complex, and is expensive for conducting the tank-venting diagnosis. Therefore, there is a need of an improved method for detecting any malfunctioning of the tank containing diesel exhaust fluid (DEF).

### SUMMARY OF THE DISCLOSURE

in one aspect of the present disclosure, a method for detecting a malfunctioning of a tank containing fluid is disclosed. The method includes calculating a rate of consumption of the fluid in the tank. The method further includes calculating an estimated change in level of the fluid in the tank based on the rate of consumption of the fluid. The method further includes determining a measured change in level of the fluid in the tank. The method further includes comparing the estimated change in level of the fluid with the measured change in level of the fluid, The method further includes determining the malfunctioning of the tank if a difference between the estimated change in level of the fluid and the measured change in level of the fluid exceeds a predetermined value.

Other features and aspects of this disclosure will be apparent from the following description and the accompanying drawings.

### BRIEF DESCRIPTION OF THE DRAWINGS

FIG. 1 illustrates a schematic view of a system for treating exhaust of a diesel engine, the system including a tank containing fluid, in accordance with the concepts of the present disclosure;

FIG. 2 illustrates a schematic view of the tank having a cap with air-passages, in accordance with the concepts of the present disclosure;

FIG. 3 illustrates a schematic view of the tank having the cap with blocked air-passages, in accordance with the concepts of the present disclosure; and

FIG. 4 illustrates a flowchart of a method for detecting a malfunctioning of the tank containing the fluid, in accordance with the concepts of the present disclosure.

### DETAILED DESCRIPTION

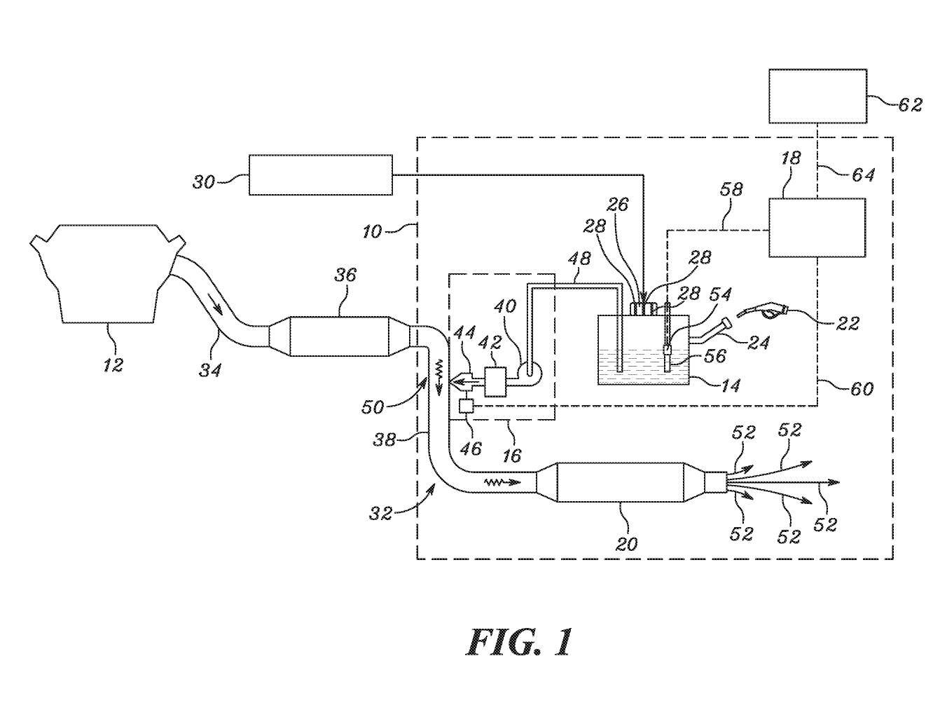

Referring to FIG. 1, a system 10 for treating exhaust of a diesel engine 12 is provided. The system 10 includes a tank 14, a dispensing system 16, a processor 18, and a catalytic converter 20. The tank 14 contains fluid and air. In an embodiment, the fluid contained in the tank 14 is a diesel exhaust fluid (DEF). The DEF is a clear non-hazardous liquid made up of a solution of about 32.5% high purity urea in de-mineralized water. The DEF is replenished in the tank 14 by a nozzle 22. The nozzle 22 is further connected to a DEF supply (not shown). The nozzle 22 dispenses the DEF into a first conduit 24 coupled to the tank 14. The tank 14 is provided with a cap 26 with a number of air passages 28 to receive air into the tank 14 from an atmosphere 30. It will be apparent to one skilled in the art that the air from the atmosphere 30 may be provided to the tank 14 by various mechanisms such as, but not limited to, the air passages 28 in the cap 26, a breather system (not shown) coupled to the tank 14 without departing from the meaning and the scope of the disclosure.

An exhaust conduit 32 is adapted to receive exhaust from the diesel engine 12. The exhaust conduit 32 includes a second conduit 34, a filter 36, and a third conduit 38. The diesel engine 12 is in fluid communication with the filter 36 via the second conduit 34. Further, the filter 36 is in fluid communication with the catalytic converter 20 via the third conduit 38. The exhaust, discharged from the diesel engine 12 into the second conduit 34 of the exhaust conduit 32, includes nitrogen oxides (NOₓ), particulate matter (PM), unburned hydrocarbons (HC), carbon monoxide (CO), among others. The filter 36 traps the particulate matter (PM) when the exhaust flows into the filter 36. Further, the exhaust free from the particulate matter (PM) is discharged into the third conduit 38 of the exhaust conduit 32.

The dispensing system 16 includes a pump 40, a flow meter 42, an injector 44, and a sensor module 46. The pump 40 is in fluid communication with the tank 14 and is adapted to draw the DEF from the tank 14 via a fourth conduit 48. The pump 40 is coupled to the flow meter 42, which is further coupled to the injector 44. The flow meter 42 is adapted to regulate the flow of the DEF received from the pump 40 into the injector 44. The injector 44 is coupled to the sensor module 46. The injector 44 injects a small quantity of the DEF into a mixing zone 50 in the third conduit 38 of the exhaust conduit 32. The mixing zone 50 corresponds to a zone where the small quantity of the DEF is mixed with the nitrogen oxides (NOₓ). The DEF injected into the mixing zone 50 hydrolyzes into ammonia (NH₃) and carbon dioxide (CO₂). Further, the ammonia (NH₃) from the DEF and the nitrogen oxides (NO) flow from the third conduit 38 into the catalytic converter 20. The ammonia (NH₃) and the nitrogen oxides (NOₓ) react in presence of a catalyst provided in the catalytic converter 20. The ammonia (NH₃) reduces the nitrogen oxides (NO) in the catalytic converter 20 into nitrogen (N₂) and water (H₂O), as shown by arrows 52.

A level sensor 54 is provided in the tank 14. The level sensor 54 is configured to measure a change in level of the fluid in the tank 14. The level sensor 54 is supported in the tank 14 by a fifth conduit 56. The processor 18 is coupled to the level sensor 54 in the tank 14 via a first communication line 58. The processor 18 is further coupled to the sensor module 46 in the dispensing system 16 via a second communication line 60. The sensor module 46 includes a pressure sensor (not shown) and a time sensor (not shown). The processor 18 is coupled to a dashboard 62 via a third communication line 64.

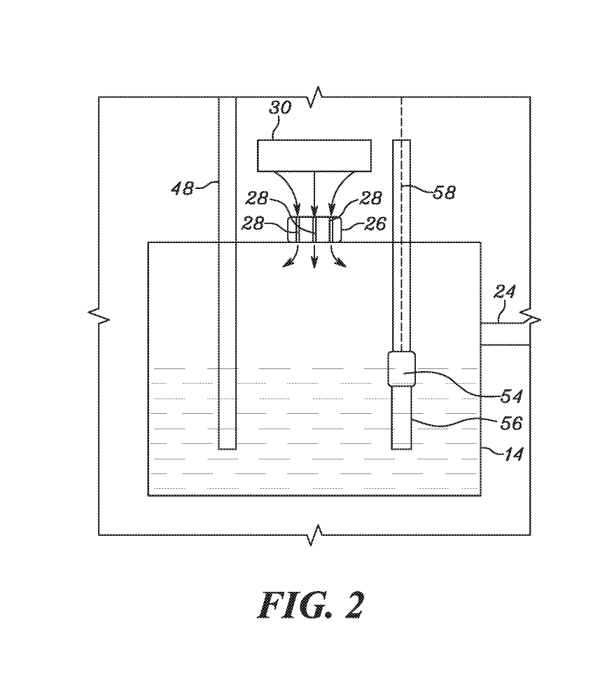

Referring to FIGS. 1, and 2, the tank 14 is made up of plastic. The tank 14 receives air from the atmosphere 30 via the air passages 28 in the cap 26. As the DEF is consumed from the tank 14, the pressure in the tank 14 decreases. The air received from the atmosphere 30 into the tank 14 creates atmospheric pressure inside the tank 14 and compensates for the pressure reduced due to consumption of the DEF from the tank 14. It is essential to maintain atmospheric pressure inside the tank 14 for efficient operation of the pump 40 of the dispensing system 16 so that the pump 40 continues to draw DEF form the tank 14.

The air passages 28 in the cap 26 of the tank 14 get blocked leading to a malfunctioning in the cap 26 of the tank 14. The processor 18 of the system 10 determines the malfunctioning in the cap 26 of the tank 14. The processor 18 calculates a rate of consumption of the DEF from the tank 14. The injector 44 of the dispensing system 16 is provided with a solenoid valve (not shown). The solenoid valve (not shown) of the injector 44 is energized to inject the DEF into the mixing zone 50 of the third conduit 38 of the exhaust conduit 32. The pressure sensor (not shown) of the sensor module 46, connected to the injector 44, records the supply pressure of the DEF into the mixing zone 50 of the third conduit 38. The pressure sensor (not shown) of the sensor module 46, connected to the processor 18 via the second communication line 60, communicates the recorded supply pressure to the processor 18. The time sensor (not shown) of the sensor module 46 measures the duration of injection of the DEF into the exhaust conduit 32. The processor 18 references the map of the supply pressure and the duration of injection of the DEF to calculate the rate of consumption of DEF in the tank 14.

The level of the DEF in the tank 14 decreases when DEF is injected into the exhaust conduit 32. The processor 18 calculates an estimated change in level of the DEF in the tank 14 based on the rate of consumption of the DEF and the dimensions of the tank 14. The level sensor 54 determines a measured change in level of the DEF in the tank 14. The level sensor 54, connected to the processor 18 by the first communication line 58, communicates the measured change in level of the DEF in the tank 14 to the processor 18. The processor 18 compares the estimated change in level of the DEF with the measured change in level of the DEF in the tank 14.

The processor 18 determines the malfunctioning of the tank 14 if a difference between the estimated change in level of the DEF and the measured change in level of the DEF exceeds a predetermined value. The measured change in level of the DEF is less than the estimated change in level of the DEF if the tank 14 malfunctions. The processor 18 indicates an error to the dashboard 62 if the malfunctioning is determined by the processor 18. The dashboard 62 displays the error to an operator (not shown). The operator (not shown), after identifying the error, cleans the cap 26 or replaces the cap 26 of the tank 14. The indication of the error by the processor 18 depends on the degree of the error. If the error is large, the processor 18 indicates the error to the dashboard 62 else, if the error is small as set within the prescribed limit, the processor 18 does not indicate the error to the dashboard 62 but saves the error. The error is analyzed further by service engineers during maintenance of a machine (not shown).

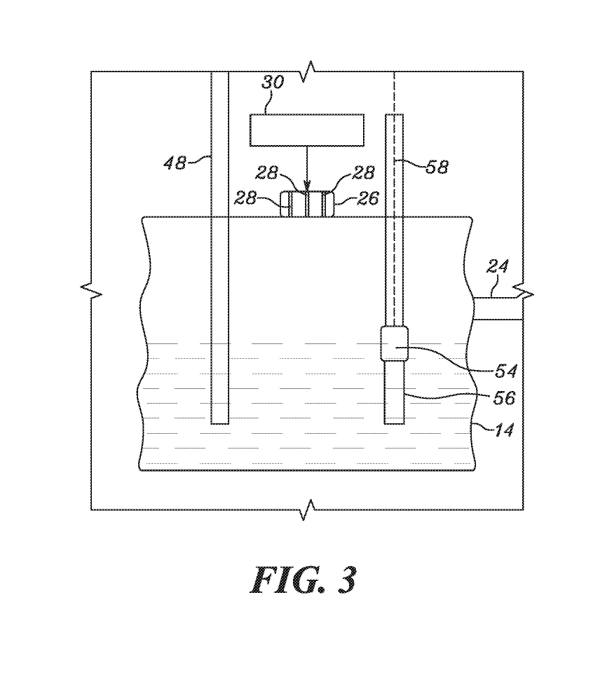

Referring to FIG. 3, the air passages 28 in the cap 26 of the tank 14 are blocked. The air passages 28 in the cap 26 of the tank 14 get blocked either with debris from surrounding environment or with the dried DEF. Some amount of DEF enters the air passages 28 of the cap 26 when the machine (not shown) moves at extreme angles. The DEF in the cap 26 dries, when exposed to the air in the air passages 28 in the cap 26, leaving behind crystallized urea, and leading to blockage of air passages 28. In the absence of air inside the tank 14, the atmospheric pressure decreases and fails to compensate the reduction in pressure due to consumption of the DEF inside the tank 14. As a result, vacuum is created inside the tank 14 and the tank 14 shrinks. The level sensor 54 determines the measured change in level of the DEF in the tank 14 to be less than expected. The delivery efficiency of the pump 40 is reduced, and thereby leading to failure of the dispensing system 16.

It should be noted that the tank 14 may be made from materials which are as stiff as plastic. It will be apparent to one skilled in the art that the dispensing system 16 may operate without expensive instruments such as the flow meter 42 and the solenoid valve (not shown). The dispensing system 16 may include a metering pump (not shown), instead of the solenoid valve (not shown), that doses the amount of DEF injected in the exhaust conduit 32 without departing from the meaning and the scope of the disclosure.

### INDUSTRIAL APPLICABILITY

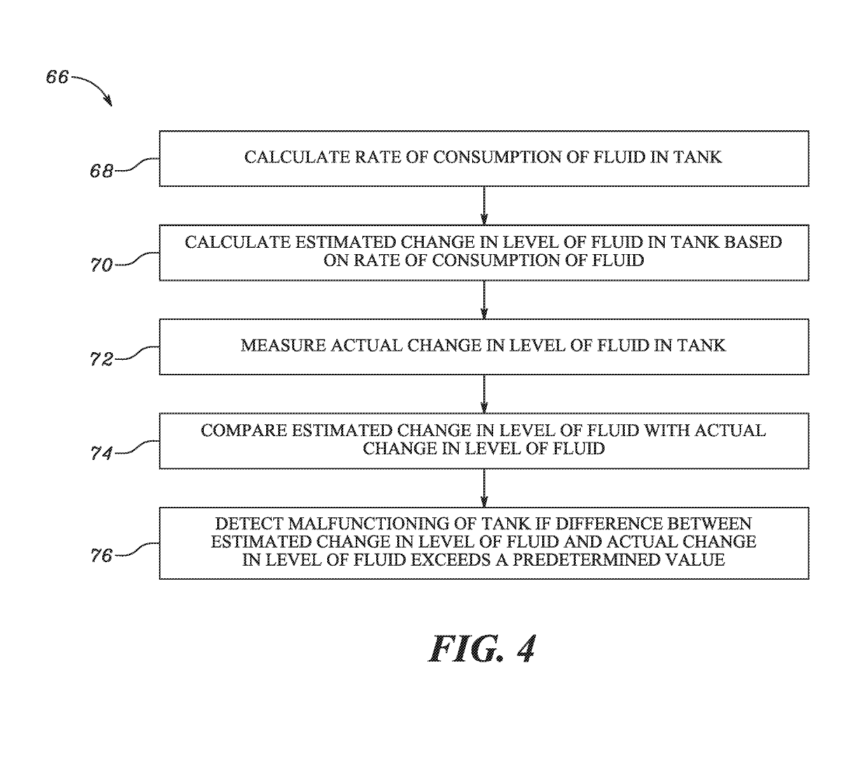

Referring to FIG. 4, a method 66 for detecting the malfunctioning of the tank 14 containing fluid is described in conjunction with FIGS. 1, 2, and 3. At step 68, the processor 18 calculates the rate of consumption of the fluid (i.e. the diesel exhaust fluid (DEF)) in the tank 14. The processor 18 calculates the rate of consumption of the DEF by referencing a map of supply pressure and the duration of injection of the DEF in the exhaust conduit 32. At step 70, the processor 18 calculates the estimated change in level of the DEF in the tank 14 based on the rate of consumption of the DEF. At step 72, the level sensor 54 determines the measured change in level of the DEF in the tank 14. The level sensor 54, connected to the processor 18 via the first communication line 58, communicates the measured change in level of the DEF to the processor 18. At step 74, the processor 18 compares the estimated change in level of the DEF with the measured change in level of the DEF. At step 76, the processor 18 determines the malfunctioning of the tank 14 if the difference between the estimated change in level of the diesel exhaust fluid and the measured change in level of the diesel exhaust fluid exceeds a predetermined value.

The present disclosure discloses the method 66 for detecting the malfunctioning of the tank 14. The method 66 efficiently detects that the cap 26 is blocked (as shown in FIG. 3). The processor 18 compares the estimated change in level of the DEF in the tank 14 with the measured change in level of the DEF in the tank 14. The processor 18 determines the malfunctioning of the tank 14 if a difference between the estimated change in level of the DEF in the tank 14 and the measured change in level of the tank 14 exceeds a predetermined value. Further, the processor 18 indicates an error to the dashboard 62 informing the operator if the malfunctioning is determined. The operator of the machine immediately changes the cap 26 or replaces the cap 26, which is blocked, so that the air from the atmosphere 30 continues to enter the tank 14. The method 66 ensures the proper working of the dispensing system 16 so that the system 10 treats exhaust of the diesel engine 12 without any failure. The method 66 is a cost effective method to detect the malfunctioning of the tank 14 and the method 66 provides real time indication of the malfunctioning of the tank 14 to the operator through the dashboard 62.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for detecting a malfunctioning of a tank containing fluid, the method comprising:
calculating, by a processor, a rate of consumption of the fluid in the tank;
calculating, by the processor, an estimated change in level of the fluid in the tank based on the rate of consumption of the fluid;
determining, by a level sensor, a measured change in level of the fluid in the tank;
comparing, by the processor, the estimated change in level of the fluid with the measured change in level of the fluid; and
determining, by the processor, the malfunctioning of the tank if a difference between the estimated change in level of the fluid and the measured change in level of the fluid exceeds a predetermined value.

2. The method of claim 1, wherein the fluid is a diesel exhaust fluid.

3. The method of claim 1, wherein the malfunctioning of the tank is a blockage of an air passage in a cap of the tank.
